(19) United States
(12) Patent Application Publication
(10) Pub. No.: US 2015/0335522 A1
(43) Pub. Date: Nov. 26, 2015

(54) CARDIOPULMONARY RESUSCITATION ASSISTING DEVICE

(71) Applicant: NIHON KOHDEN CORPORATION, Tokyo (JP)

(72) Inventors: Hiroyuki OKADA, Tokyo (JP); Tatsuo YOSHIDA, Tokyo (JP)

(73) Assignee: NIHON KOHDEN CORPORATION, Tokyo (JP)

(21) Appl. No.: 14/711,875

(22) Filed: May 14, 2015

(30) Foreign Application Priority Data
May 23, 2014 (JP) 2014-107227

(51) Int. Cl. A61H 31/00

(52) U.S. Cl. CPC A61H 31/007

(57) ABSTRACT

A cardiopulmonary resuscitation assisting device which is to be placed between a rescuee and a rescuer, during execution of cardiopulmonary resuscitation (CPR), assist the cardiopulmonary resuscitation, the cardiopulmonary resuscitation assisting device may include a first housing member which constitutes a housing, and which has a spring-like property.

### CROSS-REFERENCE TO RELATED APPLICATION(S)

This application is based upon and claims the benefit of priority from prior Japanese patent application No. 2014-107227, filed on May 23, 2014, the entire contents of which are incorporated herein by reference.

### BACKGROUND

The presently disclosed subject matter relates to a cardiopulmonary resuscitation assisting device.

CPR (CardioPulmonary Resuscitation) is a technique which is essential in the field of the emergency medical service, and the life and death of the rescuee (patient) depend on the adequateness of the technique. When CPR is to be performed, the rescuer compresses the sternum which is in the upper side of the chest. Instead of the heart of the patient, this compression can cause oxygenated blood to circulate through the whole living body. As an index of the chest compression, it is considered effective to apply a compression displacement of 5 cm or more.

Since CPR relates to the life and death of the rescuee, devices each of which is placed between the chest of the rescuee and the hands of the rescuer to assist the chest compression have been developed. In each of the devices, it is detected whether an adequate force is applied at proper time intervals to the sternum or not, and, in accordance with the detection result, appropriate notification (such as “Insufficient force” or “Compression timing is too late”) is given to the rescuer. Hereinafter, related-art examples of such a device will be described. US2012/0330200A1, JP-T-2006-511267, and WO2012/073900A1 disclose related-art devices.

US2012/0330200A1 discloses a device which is placed between the chest of the rescuee and the hands of the rescuer to assist the chest compression. The device of US2012/0330200A1 has a coil-like compression spring in a housing (see FIG. 6B or the like of US2012/0330200A1). In the device, the strength and number of chest compressions are detected based on the displacement of the compression spring.

Also JP-T-2006-511267 discloses a device which is placed between the chest of the rescuee and the hands of the rescuer to assist the chest compression. The device of JP-T-2006-511267 has a repulsive gasket in a housing (see claims 1 and 7 or the like of JP-T-2006-511267). The gasket is formed by rubber or pliable plastic (paragraph 0021 of JP-T-2006-511267). In the device, the strength and number of chest compressions are detected based on the displacement of the gasket in the chest compression.

As described above, the devices of US2012/0330200A1 and JP-T-2006-511267 have the repulsive means (compression spring, rubber, or plastic) for, when the rescuer releases the chest compression, repelling the surface contacting with the rescuer from that contacting with the rescuee, in the housing. However, the configuration where such repulsive means is disposed in a housing causes a problem in that the number of components of such a device is increased.

### SUMMARY

The presently disclosed subject matter may provide a cardiopulmonary resuscitation assisting device in which the chest compression is adequately detected or measured with a small number of components.

The cardiopulmonary resuscitation assisting device which is to be placed between a rescuee and a rescuer, during execution of cardiopulmonary resuscitation (CPR), to assist the cardiopulmonary resuscitation, may comprise: a first housing member constituting a housing, and having a spring-like property.

The cardiopulmonary resuscitation assisting device may further comprise: a second housing member constituting the housing, connected to the first housing member, and formed by a non-repulsive member.

The first housing member may be a plate spring.

The first housing member may include an embossed portion having a convex shape, in a substantially central part.

The second housing member may include a plurality of projections which are contacted with an inner edge of the first housing member, thereby fixing or supporting the first housing member.

The cardiopulmonary resuscitation assisting device may further comprise: a contacting member which is connected to the first housing member to be in contact with a chest of the rescuee.

A project area of the contacting member may be smaller than a project area of the first housing member.

The contacting member may be fixed to or supported by a substantially central part of the first housing member.

A surface of the contacting member may have a planar shape which has a width and a height, and the width and the height are different from each other in length.

The planar shape may be an elliptic shape.

The planar shape may have a width of 3 cm to 4.5 cm.

The planar shape may have a height of 7 cm to 10 cm.

There is also provided the cardiopulmonary resuscitation assisting device which may comprise: a first housing member which constitutes a housing on a side of a chest of a rescuee; and a contacting member which is connected to the first housing member to be in contact with the chest of the rescuee, wherein a project area of the contacting member is smaller than a project area of the first housing member.

### BRIEF DESCRIPTION OF THE DRAWINGS

FIG. 1 is a perspective view showing the external configuration of a cardiopulmonary resuscitation assisting device 1 of Embodiment 1.

FIG. 2 is a sectional view of the cardiopulmonary resuscitation assisting device 1 of Embodiment 1.

FIG. 3 is a sectional view of the cardiopulmonary resuscitation assisting device 1 of Embodiment 1 and showing a state where, when the chest compression is performed, a load is applied and a first housing member 10 is deformed.

FIG. 4 is a plan view showing the structure of the first housing member 10 in Embodiment 1.

FIG. 5 is a plan view showing the structure of a contacting member 50 in Embodiment 1.

FIG. 6 is a plan view showing relationships between the contacting member 50 and the first housing member 10 in Embodiment 1.

FIG. 7 is a plan view showing the structure of a second housing member 20 in Embodiment 1.

FIG. 8 is a block diagram showing the configuration of the cardiopulmonary resuscitation assisting device 1 of Embodiment 1.

FIG. 9 is a block diagram showing the configuration of the cardiopulmonary resuscitation assisting device 1 of Embodiment 1.

FIG. 10 is a sectional view showing a modification of the first housing member 10 and the contacting member 50 in the presently disclosed subject matter.

### DETAILED DESCRIPTION OF EXEMPLARY EMBODIMENTS

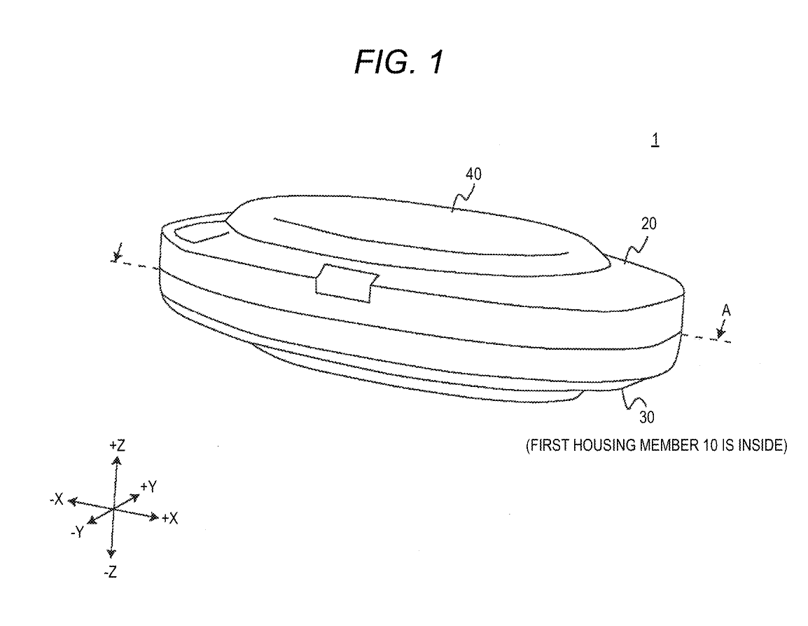

Hereinafter, an embodiment of the presently disclosed subject matter will be described with reference to the drawings. FIG. 1 is a perspective view showing the external configuration of a cardiopulmonary resuscitation assisting device 1 of the embodiment. In the drawings described in the specification, in order to make the drawings easily readable, the illustration may be sometimes adequately simplified, or the scale and position of a part of components may be different from those of the actual specifications.

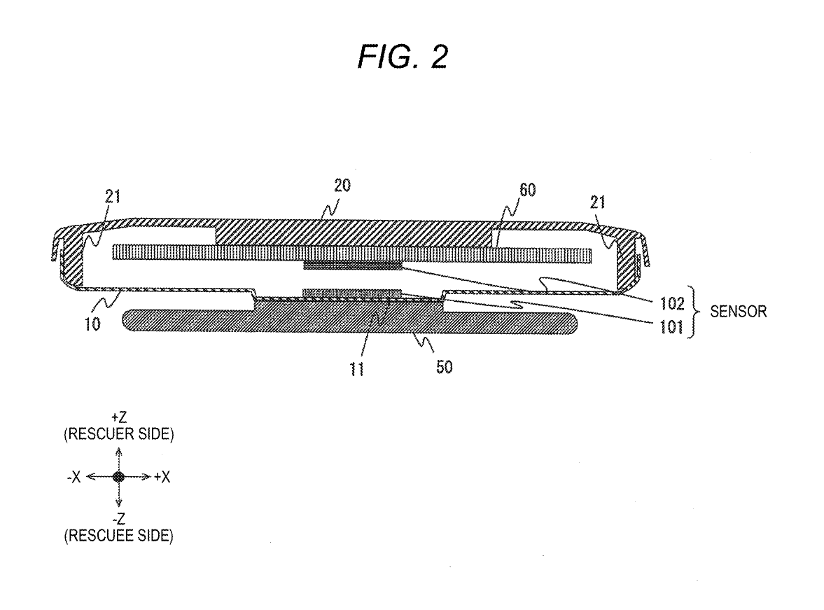

The cardiopulmonary resuscitation assisting device 1 is a device which is placed between the chest (preferably, just above the sternum) of the rescuee and the hands of the rescuer to assist the chest compression. The rescuee is a concept containing an injured or sick human (or alternatively referred to as a patient) and also a mannequin and the like. Namely, the cardiopulmonary resuscitation assisting device 1 may be used not only in a situation where the chest compression is actually performed, but also in the training of the chest compression. The cardiopulmonary resuscitation assisting device 1 detects the depth and number of chest compressions by using displacements which are detected by a sensor when the compression is applied and released. Therefore, the cardiopulmonary resuscitation assisting device 1 must have a spring property in which, when the compression is applied, a displacement is produced. The method of realizing the spring property will be described in detail with reference to FIG. 2 and other figures.

The housing of the cardiopulmonary resuscitation assisting device 1 includes a first housing member 10 (not shown in FIG. 1) and a second housing member 20. The first housing member 10 and the second housing member 20 are fitted to each other to constitute the housing of the cardiopulmonary resuscitation assisting device 1. FIG. 1 shows a shape in which an elastic cover 30 for covering the first housing member 10 is attached, and a battery cover 40 is attached to the second housing member 20.

In the following description, the directional axes (the X-axis, the Y-axis, and the Z-axis) are defined as shown in FIG. 1. The positive direction of the Z-axis (+Z direction) coincides with the surface in which the rescuer and the cardiopulmonary resuscitation assisting device 1 are to be contacted with each other, and therefore is referred to also as “rescuer side”. Similarly, the negative direction of the Z-axis (−Z direction) coincides with the surface in which the rescuee and the cardiopulmonary resuscitation assisting device 1 are to be contacted with each other, and therefore is referred to also as “rescuee side”.

The cardiopulmonary resuscitation assisting device 1 is placed on the chest (preferably, just above the sternum) of the rescuee so that the first housing member 10 is located in the lower side. The rescuer compresses a planar place (in the example of FIG. 1, the vicinity of the battery cover 40) of the second housing member 20, thereby performing the chest compression. When the rescuer performs compression, the pressure is transmitted in the direction from the lower surface of the first housing member 10 to the chest of the rescuee. Mainly, an adult rescuer uses the cardiopulmonary resuscitation assisting device 1 to perform compression while holding the device with the hands. Therefore, the device preferably has dimensions conforming to the size of the palm of an adult. In the case where the second housing member 20 is viewed from the rescuer side (+Z direction), for example, the member may have a shape in which the major diameter has a length of about 10 to 15 cm and the minor diameter has a length of about 5 to 10 cm. When the member has a such size, the member fits the hand of the rescuer. Therefore, the rescuer can continuously perform the chest compression while the cardiopulmonary resuscitation assisting device 1 is kept to be fixed to the vicinity to the sternum of the rescuee.

Hereinafter, the chest compression will be briefly described. In the chest compression, adequatenesses of (1) number, (2) depth (compression depth), and (3) returning largely affect the effect of resuscitation. It is considered that the chest compression number is preferably about 100 times to per minute or more. It is considered that, in the case where the rescuee is an adult, the chest compression is satisfactorily performed at the compression depth of 5 cm or more. With respect to the compression strength in the chest compression, a load of 400 N or more in terms of a force is preferable in the case of a mannequin. When the compression depth is excessively small, the massage effect on the heart is not sufficient, and, when the compression depth is excessively large, there is a possibility that the sternum or the like is damaged. Immediately after each compression by the procedure of the rescuer, moreover, the chest must be sufficiently released. When the release is not sufficient, the blood is insufficiently circulated. The cardiopulmonary resuscitation assisting device 1 measures the actual depth and number (compression speed) of compressions, and compares the measured values with the indexes (5 cm or more and 100 times per minute).

The internal structure of the cardiopulmonary resuscitation assisting device 1 will be further described with reference to the sectional view of FIG. 2. FIG. 2 shows a section taken along line A-A in FIG. 1. In FIG. 2, the elastic cover 30 and the battery cover 40 are not shown, and also screws and the like for connecting components to each other, and electronic components mounted on a circuit board 60 are not shown.

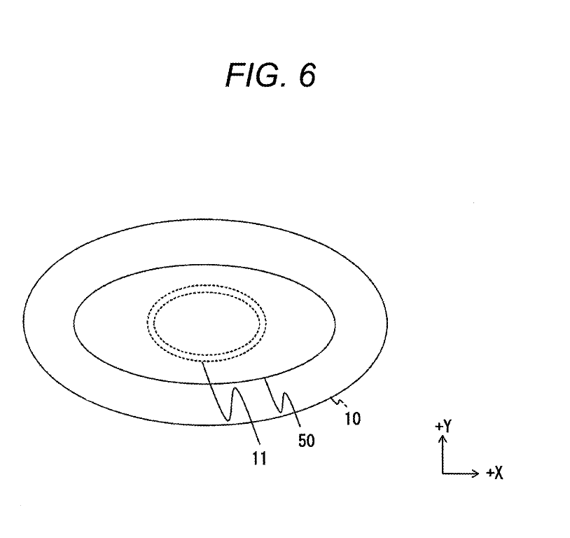

The second housing member 20 is a member to which a pressure is directly applied by the procedure of the rescuer, and a non-repulsive member (member which does not have a spring-like property). The second housing member 20 is physically connected to the first housing member 10 and the printed circuit board 60. For example, the second housing member 20 is screwed to the first housing member 10 and the printed circuit board 60 by using screw holes and screws which are not shown. The second housing member 20 has a plurality of projections 21. The plurality of projections 21 are in approximate contact with the inner edge of the first housing member 10 to support the first housing member 10. The shape of the projections 21 will be described later with reference to FIG. 6.

The rescuer applies a pressure on the upper surface of the second housing member 20 (applies a pressure from the rescuer side (+Z direction) toward the rescuee side (−Z direction)), thereby performing the chest compression.

Various circuits and software for detecting and measuring the strength and speed (compression number) of the chest compression performed by the rescuer are mounted on the printed circuit board 60.

The first housing member 10 cooperates with the second housing member 20 to constitute the device housing of the cardiopulmonary resuscitation assisting device 1. The first housing member 10 is a member having a spring-like property (repulsive member). In other words, the first housing member 10 deflects in the +Z direction (rescuer side) when applying the pressure in the chest compression, and returns in the −Z direction (rescuee side) when releasing the pressure. For example, the first housing member 10 is a plate spring. In the cardiopulmonary resuscitation assisting device 1, the first housing member 10 functions as a repulsive member, and therefore a repulsive member is not disposed in the housing.

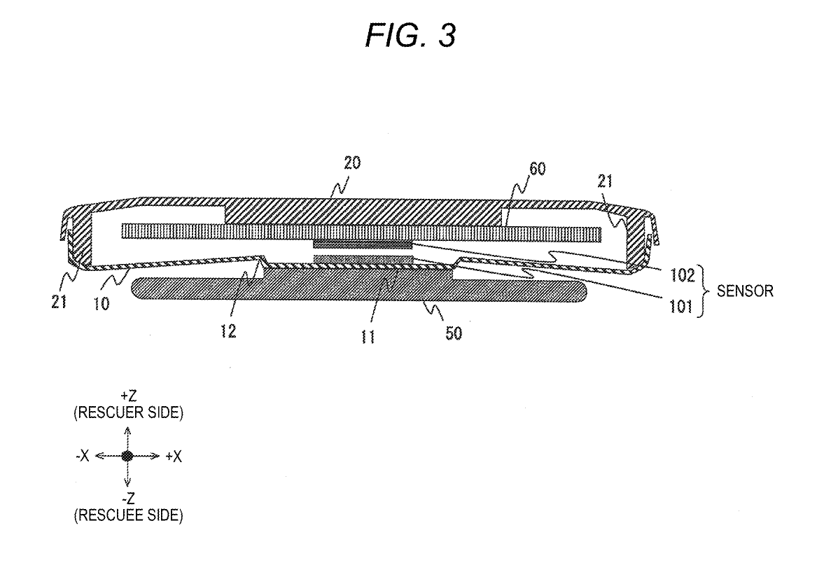

In the first housing member 10, an embossed portion 11 which is convex in the −Z direction (rescuee side) is configured in a central portion. Since the embossed portion 11 which is convex in the −Z direction (rescuee side) is disposed, the displacement occurring inside the embossed portion 11 becomes uniform, and the deflection angle can be made small. When the deflection angle inside the embossed portion 11 is reduced, the embossed portion 11 planarly moves in parallel (in other words, vertically moves). FIG. 3 shows a state of the cardiopulmonary resuscitation assisting device 1 which is formed during the chest compression. As shown in FIG. 3, the first housing member 10 outside the embossed portion 11 largely deflects. However, the planar part of the embossed portion 11 moves only in the vertical direction as shown in FIG. 3. As a result, it is possible to suppress distortion occurring in a sensor 101 disposed in the embossed portion 11 of the cardiopulmonary resuscitation assisting device 1.

In the case where the disposition of the embossed portion 11 causes the spring constant to be non-linear, when the embossed portion 11 is formed into an acute-angled shape, the spring constant can approach a desired one.

The first housing member 10 is made of a non-magnetic material such as stainless steel. According to the configuration, the first housing member 10 exerts no influence on coils 101 and 102 disposed on the printed circuit board 60. When the first housing member 10 is made of stainless steel, effects such as that, even when the member is wetted, the member is hardly rusted are achieved.

For example, the spring constant of the first housing member 10 may be about 200 N/mm to 1,000 N/mm.

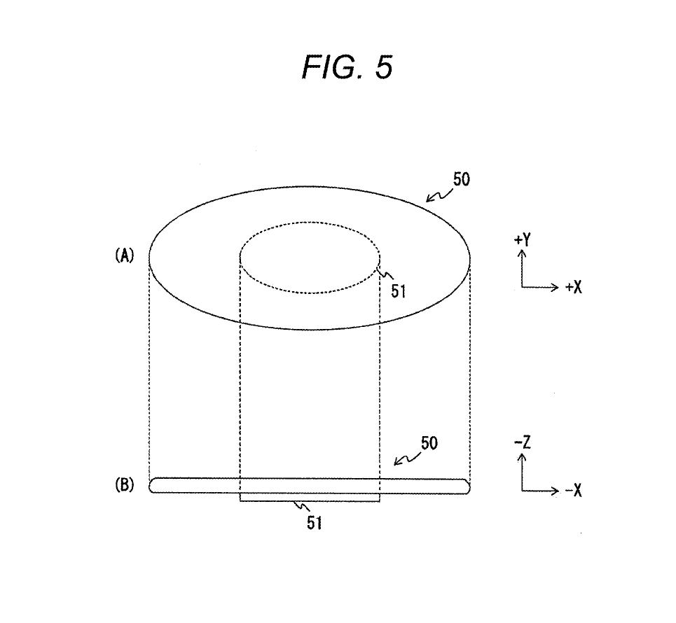

A contacting member 50 is attached to the embossed portion 11 which is in a substantially central part of the first housing member 10. The contacting member 50 is a member which is to be directly (or through the elastic cover 30 shown in FIG. 1) contacted with the chest (preferably, just above the sternum) of the rescuee. In the specification, a direct contact of the contacting member 50 with the chest of the rescuee, or a contact of the member with the chest through the elastic cover 30 (and a buffering member) is expressed as “the contacting member 50 is contacted with the rescuee.” The contacting member 50 will be described later in detail with reference to FIGS. 5 and 6.

The coil 101 is fixed to the vicinity of the embossed to portion 11 inside the first housing member 10 by means of screwing or the like. By contrast, the coil 102 is fixed to a position which is on the printed circuit board 60, and which is opposed to the coil 101, by means of screwing or the like. The coils 101 and 102 constitute a mode of a sensor which electrically detects a displacement caused by the chest compression. The sensor for detecting the displacement may be configured by another kind of sensor. The displacement to be detected may not be an electric displacement. For example, the displacement may be detected by using an optical sensor. Alternatively, a distortion sensor which is applied to the inside of the first housing member 10 may detect distortion, and convert the distortion to a displacement.

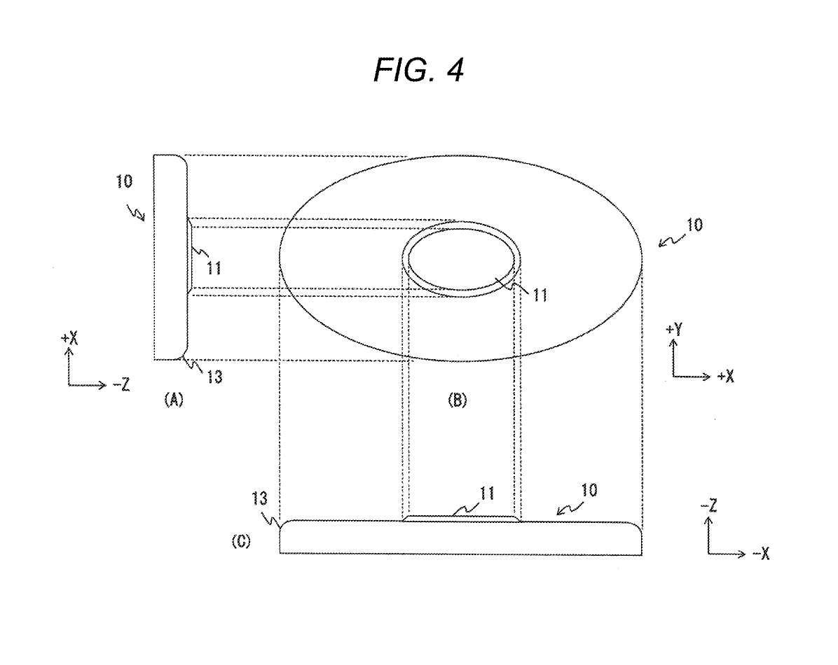

Then, the structure of the first housing member 10 will be further described with reference to FIG. 4. In FIG. 4, (A) shows a plan view in the case where the minor diameter of the elliptic shape of the first housing member 10 is vertically directed, (B) shows a plan view in the case where the first housing member 10 is viewed in the −Z direction (the rescuee side), and (C) shows a plan view in the case where the major diameter of the elliptic shape of the first housing member 10 is laterally directed.

As shown in (A) to (C) of FIG. 4, the first housing member 10 has the embossed portion 11 which is convex in the −Z direction (the rescuee side), in a substantially central part. In the to case where the embossed portion 11 is disposed, the maximum distortion in the first housing member 10 is produced in an outer edge portion 12 which is outside the embossed portion 11 (see FIG. 3). As shown in FIG. 2 described above, the contacting member 50 is attached to the embossed portion 11. Therefore, contact shapes such as screw holes which are not shown are disposed in the embossed portion 11.

Preferably, a corner portion 13 of the first housing member 10 in the −Z direction (the rescuee side) has an arcuate shape as shown in (A) and (C) of FIG. 4. This is because there is a possibility that the corner portion 13 may be contacted with the chest of the rescuee, and, when an arcuate shape is formed, it is possible to prevent the body surface of the rescuee from being damaged.

Next, the structure of the contacting member 50 will be described with reference to FIG. 5. The contacting member 50 is a member which is to be in contact with the sternum of the rescuee. In FIG. 5, (A) shows a plan view in the case where the contacting member 50 is viewed in the −Z direction (the rescuee side), and (B) shows a plan view in the case where the major diameter of the contacting member 50 is laterally directed.

The contacting member 50 has a contacting portion 51 which is convex in the +Z direction (rescuer side). The contacting portion 51 is connected to the embossed portion 11 of the first housing member 10. For example, the contacting portion 51 and the embossed portion 11 are screw-connected to each other.

The surface (the surface to be contacted with the rescuee, and the elliptical area enclosed by a solid line in (A) of FIG. 5) of the contacting member 50 has an elliptical shape of a size extending along the sternum of the rescuee. The member has the following approximate size. The height (the length in the X-axis direction, and the major diameter of the elliptic shape) of the contacting member 50 is about 7 to 10 cm. The width (the length in the Y-axis direction, and the minor diameter of the elliptic shape) of the contacting member 50 is about 3 to 4.5 cm. These dimensions are determined based on the usual width of the sternum, and the like. The height direction of the planar shape of the contacting member 50 coincides with the elongated direction of the sternum of the rescuee.

Since the width of the planar shape of the contacting member 50 has a length (3 to 4.5 cm)) along the width of the sternum, the contacting member 50 is fixed so as to extend along the sternum. Therefore, the cardiopulmonary resuscitation assisting device 1 can be prevented from being positionally displaced during the chest compression.

Since the planar shape of the contacting member 50 has a height of about 7 to 10 cm, moreover, the contact area between the contacting member 50 and the rescuee is ensured to be larger than a given value. Therefore, the rescuer can stably continue to the chest compression.

The structures of the contacting member 50 and the first housing member 10 will be further described with reference to FIG. 6. FIG. 6 is a plan view in the case where the contacting member 50 and the first housing member 10 are viewed in the −Z direction (rescuee side) in a state where the contacting member 50 is attached to the first housing member 10.

As illustrated, the contacting member 50 is attached to the substantially central part of the first housing member 10. As illustrated, the project area of the contacting member 50 (the area of the surface in the case where the contacting member 50 is viewed in the −Z direction (the rescuee side)) is smaller than the project area of the first housing member 10 (the area of the surface in the case where the first housing member 10 is viewed in the −Z direction (the rescuee side)).

Since the project area of the contacting member 50 is smaller than that of the first housing member 10 as described above, a necessary force is transmitted without waste to the chest of the rescuee while the pressure given by the rescuer (the pressure for the chest compression) is concentrated into the size of the project area of the contacting member 50.

As described above, the contacting member 50 is fixed to the substantially central part of the first housing member 10 (i.e., the embossed portion 11). According to the configuration, even when the rescuer presses a place other than to the central part of the second housing member 20, the given pressure can be transmitted to the chest of the rescuee while being concentrated into the contacting member 50. In other words, even when the treatment is performed in a state where the place where the pressure is applied is deviated, the rescuer can adequately compress the sternum.

The configuration where the planar shape of the contacting member 50 is elliptic is a mere example. The contacting member 50 is required to have a planar shape which has the width and height that are different from each other in length. Specifically, the contacting member 50 may have a planar shape which has the height arranged in the extending direction of the sternum (in the height direction of the rescuee), and the width arranged in the width direction of the sternum. In the case of the above-described elliptic shape, the minor diameter corresponds to the width, and the major diameter corresponds to the height. Alternatively, the planar shape of the contacting member 50 may be an edge-rounded rectangular shape, a hexagonal shape, a so-called gourd shape, or the like. Even in the case where the contacting member 50 has a rectangular shape or the like, the width direction of the planar shape is made coincident with that of the sternum, and therefore an effect that the chest compression can be adequately performed as described above is achieved.

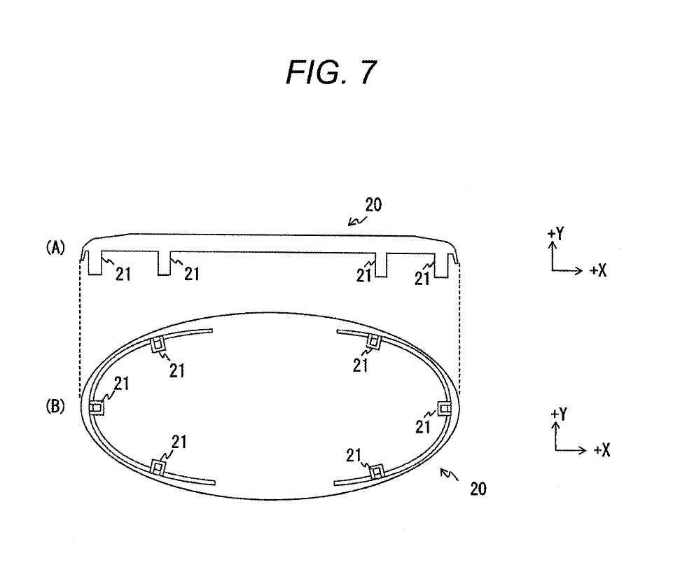

Next, the configuration of the second housing member 20 will be described with reference to FIG. 7. In FIG. 7, (A) is a plan view in the case where the major diameter direction of the second housing member 20 is laterally arranged, and (B) is a plan view in the case where the second housing member 20 is viewed in the direction (the rescuee side).

As illustrated, a plurality of projections 21 (in the example of FIG. 6, six projections 21) are disposed on the second housing member 20. The projections 21 are disposed so as to be in approximate contact with the inner edge (outer circumference) of the first housing member 10. According to the configuration, the second housing member 20 supports the first housing member 10.

The inner edge (outer circumference) of the first housing member 10 is a portion in which deformation is small. The plurality of projections 21 support the inner edge (outer circumference) of the first housing member 10 while dispersing a force applied to the inner edge (outer circumference) in which deformation is small. In other words, the second housing member 20 can apply free supporting on the first housing member 10 because the second housing member 20 has the plurality of projections 21.

Any number of projections 21 may be disposed on the second housing member 20 so long as the number is two or more. An odd number of projections 21 may be disposed. In the figure, the projections 21 are disposed on two members which are placed along the outer circumference. Alternatively, the projections may be disposed on a member which extends annularly along the outer circumference (the member has a shape which is continuous along the outer circumference).

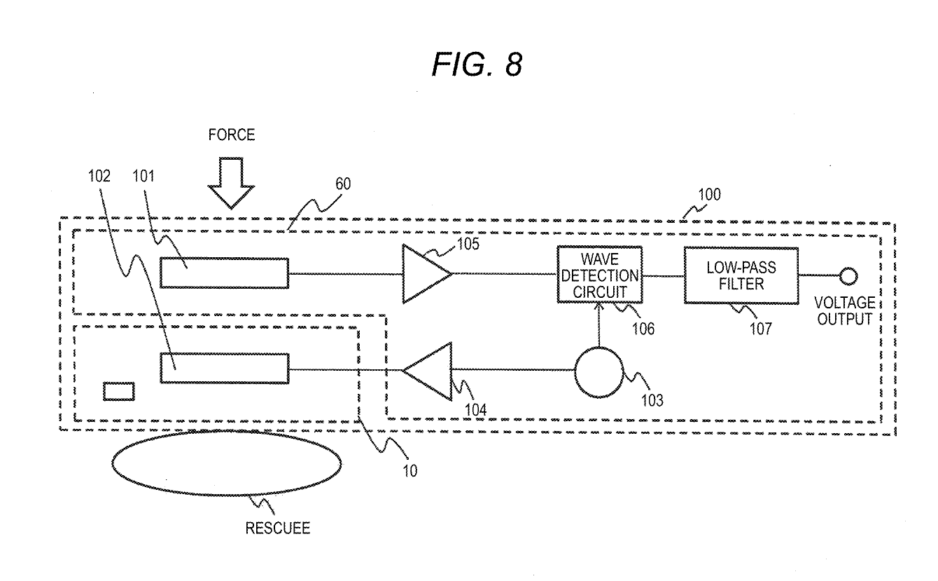

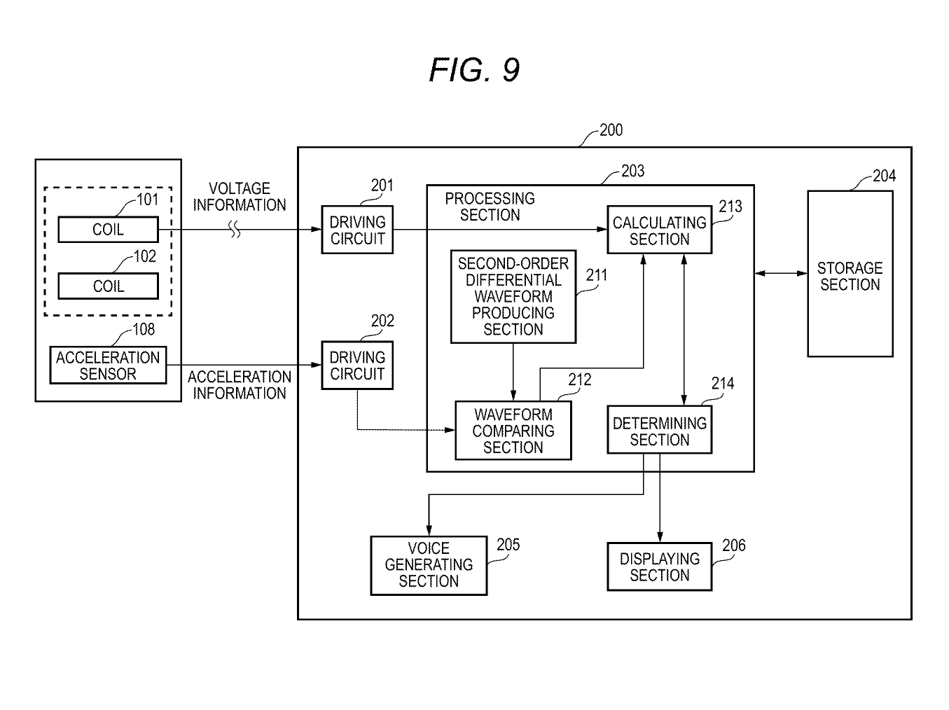

Then, the electrical process of the cardiopulmonary resuscitation assisting device 1 will be described with reference to FIGS. 8 and 9. The cardiopulmonary resuscitation assisting device 1 detects the pressure applied in the procedure by the rescuer, and, based on the detected pressure, informs the rescuer whether the procedure by the rescuer is being performed at adequate speed and strength or not. FIGS. 8 and 9 are views which are focused on the electric configuration of the cardiopulmonary resuscitation assisting device 1, and the size and the like of the device (the size and the like of the cardiopulmonary resuscitation assisting device 1 as compared to the rescuee) may be different from the actual ones.

FIG. 8 is a block diagram showing a measuring section 100 which, in the cardiopulmonary resuscitation assisting device 1, detects the pressure applied in the procedure by the rescuer, as a voltage. The value of the detected voltage is supplied to a compression depth calculating section 200 (FIG. 9) which will be described later.

As described above, the coil 101 is fixed to the vicinity of the embossed portion 11 inside the first housing member 10, and the coil 102 is fixed to the printed circuit board 60 opposed to the coil 101. In the following description, unless otherwise specified, it is assumed that processing sections and circuits are mounted on the printed circuit board 60.

An AC oscillation source 103 produces an AC voltage having a specific frequency (for example, 20 kHz). An amplifier 104 converts the AC voltage produced by the AC oscillation source 103 into an AC current, and supplies the converted AC current to the coil 102. A magnetic field which is produced by the AC current flowing through the coil 102 causes an induced electromotive force to be generated in the coil 101.

An AC current which is produced in the coil 101 by the induced electromotive force (the frequency is equal to that of the AC voltage which is produced by the AC oscillation source 103) is amplified by a preamplifier 105. The amplification signal which is amplified by the preamplifier 105 is supplied to a wave detection circuit 106. The wave detection circuit 106 performs detection on the amplification signal by the specific frequency which is produced by the AC oscillation source 103 or the double frequency. Therefore, the output of the AC oscillation source 103 is supplied as a reference signal to a reference-signal input terminal of the wave detection circuit 106. Alternatively, the voltage may be detected by using a full-wave rectifier circuit without using the wave detection circuit 106 and the reference signal.

Voltage information (output signal) output from the wave detection circuit 106 (or full-wave rectifier circuit) is passed through a low-pass filter 107, and then supplied to a driving circuit 201 (FIG. 9) in the compression depth calculating section 200. An acceleration sensor 108 supplies information of a detected acceleration to the compression depth calculating section 200.

Then, the configuration of the compression depth calculating section 200 will be described with reference to FIG. 9. The compression depth calculating section 200 has a driving circuit 201, a driving circuit 202, a processing section 203, a storage section 204, a voice generating section 205, and a displaying section 206.

The driving circuit 201 supplies the voltage information received from the low-pass filter 107 (FIG. 8), to the processing section 203. The driving circuit 202 coverts the acceleration information received from the acceleration sensor 108, into a voltage, and supplies the voltage to the processing section 203.

The processing section 203 is realized by, for example, a CPU (Central Processing Unit). The processing section 203 includes a second-order differential waveform producing section 211, a waveform comparing section 212, a calculating section 213, and a determining section 214. The second-order differential waveform producing section 211 produces a second-order differential waveform based on the voltage information acquired from the driving circuit 201. The waveform comparing section 212 compares the second-order differential waveform produced by the second-order differential waveform producing section 211 with the acceleration information received from the acceleration sensor 108. The calculating section 213 calculates a conversion coefficient abased on a result of the comparison by the waveform comparing section 212. Next, the determining section 214 determines whether the conversion coefficient α satisfies the following inequality or not. The first and second coefficients in Exp. (1) are previously stored in the storage section 204.

First coefficient<Conversion coefficient α<Second coefficient Exp. (1)

If Exp. (1) is satisfied, the determining section 214 determines that the conversion coefficient α is used as it is, and, if not satisfied, determines that the initial value of the conversion coefficient stored in the storage section 204 is used as the conversion coefficient α.

The calculating section 213 produces a waveform Dm by using the output waveform due to the coils (coils 101, 102) and the conversion coefficient α. Based on the waveform Dm, the calculating section 213 calculates the depth and interval of the compression performed by rescuer by using a conventional technique. The determining section 214 refers the storage section 204, and determines whether the compression depth and interval which have been calculated are adequate or not. The determining section 214 notifies the voice generating section 205 and the displaying section 206 of a determination result indicating whether the compression depth and the interval are adequate or not.

The storage section 204 is means for storing various kinds of information (the above-described first and second coefficients, the initial value of the conversion coefficient, and the like), and realized by, for example, a ROM (Read Only Memory), an HDD (Hard Disk Drive), or a USB (Universal Serial Bus) memory.

Base on the determination result relating to the compression depth and the interval and obtained by the determining section 214, the voice generating section 205 performs notification to the rescuer. For example, the voice generating section 205 is a speaker. In the case where the compression depth is not sufficient, the voice generating section 205 outputs voice guidance “Press more strongly.” In accordance with the determination result, similarly, the voice generating section 205 outputs further voice guidance such as “Press more weakly,” Press more slowly,” or “Press more quickly.”

The displaying section 206 is means for performing various kinds of displays, and realized by, for example, an LCD (Liquid Crystal Display) or a CRT (Cathode Ray Tube) display. The displaying section 206 displays the waveform indicating the execution of the chest compression, the number of chest compressions, the compression depth, and the like on a screen.

The process of detecting the depth and speed of the chest compression in the cardiopulmonary resuscitation assisting device 1 is substantially identical with that described in WO2012/073900A1 above. Refer the literature as necessary.

Then, the effects of the cardiopulmonary resuscitation assisting device 1 of the embodiment will be again described. In the cardiopulmonary resuscitation assisting device 1, as described above, the first housing member 10 which constitutes the housing of the device has a spring-like property. The cardiopulmonary resuscitation assisting device 1 has a configuration which does not have a repulsive member (compression spring, rubber, or plastic) in the device housing. Therefore, the cardiopulmonary resuscitation assisting device 1 can perform adequate CPR assistance although the number of components is reduced.

The above-described device of US2012/0330200A1 has the configuration in which the compression spring is disposed in the housing. In this case, a guide and holding mechanism which allow the compression spring to slide in one direction are required. Therefore, there is a problem in that a space cannot be ensured in the housing, and the device is hardly miniaturized. Similarly, the device disclosed in JP-T-2006-511267 has rubber or plastic as a repulsive member in the housing, and therefore difficult to ensure a sufficient space in the housing. In the cardiopulmonary resuscitation assisting device 1 of the embodiment, by contrast, the first housing member 10 itself which constitutes the housing has a spring-like property. In the cardiopulmonary resuscitation assisting device 1, therefore, the space in the device can be sufficiently ensured while ensuring a necessary repulsive property. Since the space in the device can be ensured, miniaturization of the whole cardiopulmonary resuscitation assisting device 1 can be realized.

In the above-described device of JP-T-2006-511267, rubber or plastic is used as the repulsive member. In training on chest compression, as described above, a pressure force of about 400 N or more is applied to the device. Also in chest compression for an actual patient, a pressure force of this degree is applied to the device. When the device is repeatedly used, therefore, there is a possibility that the repulsive property of the repulsive member may be lowered. Namely, there is a possibility that the characteristics may be changed in accordance with the use. When the characteristics are changed, there is a possibility that the pressure applied by the rescuer may not be correctly detected. In the cardiopulmonary resuscitation assisting device 1 of the embodiment, by contrast, the repulsive property is realized by the plate spring, and there is a very small possibility that the characteristics may be changed. Therefore, the cardiopulmonary resuscitation assisting device 1 can accurately detect the compression depth and the like of the chest compression performed by the rescuer.

Preferably, the first housing member 10 may be formed by a thin plate spring. When the first housing member 10 is formed by a plate spring, the space in the housing of the cardiopulmonary resuscitation assisting device 1 can be sufficiently ensured.

As described above, the first housing member 10 has embossed portion 11 which is convex in the direction of the rescuee. Therefore, distortion occurring in the sensor 101 disposed in the embossed portion 11 can be suppressed, and the cardiopulmonary resuscitation assisting device 1 can accurately detect the strength of the chest compression performed by the rescuer.

Since the plurality of projections 21 are disposed, it is possible to apply free supporting on the first housing member 10.

As shown in FIGS. 2 and 6, the cardiopulmonary resuscitation assisting device 1 has the contacting member 50 which is to be contacted with the rescuee. As shown in FIG. 6, the project area of the contacting member 50 is smaller than that of the first housing member 10. According to the configuration, the pressure given by the rescuer (the pressure for the chest compression) is transmitted to the chest of the rescuee while being concentrated into the small project area (the project area of the contacting member 50). Therefore, the chest compression can be efficiently performed.

The contacting member 50 is fixed to the substantially central part of the first housing member 10 (in the example of

FIG. 6, the embossed portion 11). According to the configuration, even when the place where the pressure is applied is deviated, the rescuer can adequately compress the sternum.

The contacting member 50 has a shape extending along the sternum of the rescuee (a shape in which the width and the height are different from each other, such as an elliptic shape as shown in FIG. 6). According to the configuration, the contacting member 50 is fixed so as to extend along the sternum, and the cardiopulmonary resuscitation assisting device 1 can be prevented from being positionally displaced during the chest compression.

Specifically, for example, the surface of the contacting member 50 has a height of about 7 to 10 cm, and a width of about 3 to 4.5 cm. These dimensions are determined in consideration of the usual size of the sternum. Since the width ranges within the above-described size range, the contacting member 50 can be surely fixed to the chest (sternum) of the rescuee, and the cardiopulmonary resuscitation assisting device 1 can be prevented from being positionally displaced during the chest compression. Since the height ranges within the above-described size range, the chest compression can be stably performed while the contact area between the rescuee and the cardiopulmonary resuscitation assisting device 1 is maintained at a given value or more.

Although the presently disclosed subject matter conducted by the inventors has been specifically described based on the embodiment, the invention is not limited to the above-described embodiment, and it is a matter of course that various changes can be made without departing from the spirit of the invention. Even in the case where the first housing member 10 is configured by another kind of repulsive member such as a disc spring, for example, the space reduction can be realized.

In the description with reference to FIG. 2 and other figures like, the configuration where the first housing member 10 which is placed in the −Z direction (rescuee side) has a repulsive property, and the second housing member 20 which is placed in the +Z direction (rescuer side) is a non-repulsive member has been described. The invention is not limited to the configuration. Namely, a housing member having a repulsive property may be placed in the +Z direction (rescuer side). Also in a configuration where the first housing member 10 and the second housing member 20 are integrated with each other, and the integrated housing member has a repulsive property, theoretically, it is possible to realize reduction of the number of components.

Even in a configuration where both the first housing member 10 and the second housing member 20 have a spring-like property, it is possible to achieve the effects that the number of components is reduced, and that a space in the device housing is ensured. In the configuration where one of the housing members (in the above description, the second housing member 20) is formed by a non-repulsive material, and a member (for example, a battery) which is to be stably supported is fixed to the non-repulsive material, however, it is possible to avoid a failure such as battery disengagement, or an erroneous operation.

From the viewpoint that the number of components of the device is reduced, it is necessary that the device housing member has a spring-like property. From the viewpoint that the chest compression is efficiently performed by using the contacting member 50, the property of the first housing member 10 is not particularly limited. Even in a cardiopulmonary resuscitation assisting device in which a repulsive member (compression spring, rubber, or plastic) is disposed in a housing as in US2012/0330200A1 and JP-T-2006-511267, namely, the contacting member 50 in which the protect area is smaller than that of the first housing member 10 may be disposed. Also in the configuration, the pressure given by the rescuer can be transmitted to the chest of the rescuee while being adequately concentrated into the contacting member 50.

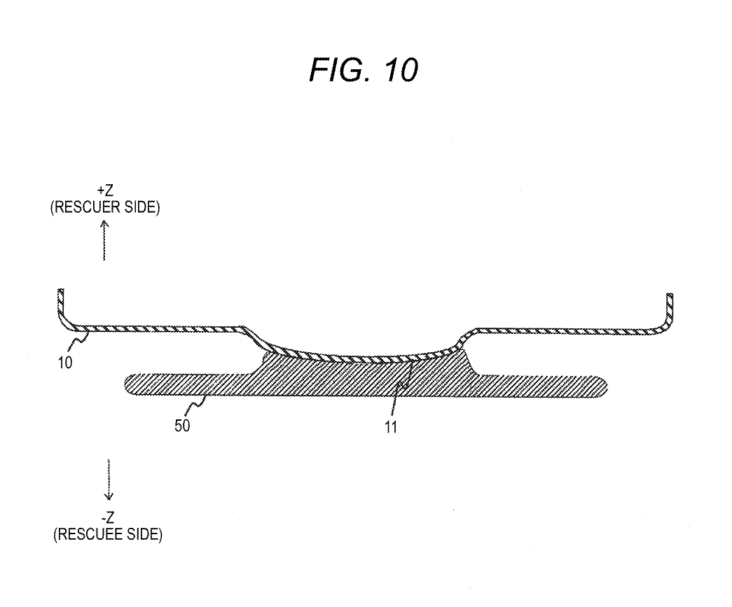

In the above, the configuration where the contacting member 50 is fixed to the substantially central part of the first housing member 10 has been described. The fixation may be performed so that the surface of the contacting member 50 is in close contact with the embossed portion 11 of the first housing member 10 (the mode of FIG. 2). The fixation includes also a configuration where the outer side of the contacting member 50 is formed so as to be rotatable (i.e., the contacting member rotatably supports the first housing member). FIG. 10 shows an example of this configuration of the contacting member 50 and the first housing member 10. Also in the configuration, even when the procedure is performed in a situation where the place where the pressure is applied by the second housing member 20 is deviated, the rescuer can adequately compress the sternum. Although, in the examples of FIGS. 2 and 10, the embossed portion 11 is configured so as to be convex in the −Z direction (rescuee side), the embossed portion 11 may be configured so as to be convex in the +Z direction (rescuer side).

According to the presently disclosed subject matter, there is provided the cardiopulmonary resuscitation assisting device which is to be placed between a rescuee and a rescuer, during execution of cardiopulmonary resuscitation (CPR), to assist the cardiopulmonary resuscitation, may comprise: a first housing member constituting a housing, and having a spring-like property.

The thus configured cardiopulmonary resuscitation assisting device has a shape in which the housing and the spring are integrated with each other, and therefore it is not necessary to dispose a spring member in the housing. Consequently, it is possible to realize reduction of the number of components.

The cardiopulmonary resuscitation assisting device may further comprise: a second housing member constituting the housing, connected to the first housing member, and formed by a non-repulsive member.

In the configuration where the second housing member is formed by a non-repulsive material, and an element (for example, a battery) which is to be stably supported is fixed to the non-repulsive material, it is possible to avoid a failure such as battery disengagement, or an erroneous operation.

The first housing member may be a plate spring.

In the configuration where the first housing member is formed by a plate spring, the degree of freedom of the shape of the device housing is enhanced, and the housing can be flexibly designed in accordance with the manner of mounting in the housing.

The first housing member may include an embossed portion having a convex shape, in a substantially central part.

Since the first housing member includes an embossed portion, it is possible to accurately measure whether the depth and number of chest compressions performed by the rescuer are adequate or not.

The second housing member may include a plurality of projections which are contacted with an inner edge of the first housing member, thereby fixing or supporting the first housing member.

In the configuration where the second housing member includes a plurality of projections, the second housing member can apply free supporting on the first housing member.

The cardiopulmonary resuscitation assisting device may further comprise: a contacting member which is connected to the first housing member to be in contact with a chest of the rescuee.

A project area of the contacting member may be smaller than a project area of the first housing member.

According to the configuration, the pressure given by the rescuer (the pressure for the chest compression) is transmitted to the chest of the rescuee while being concentrated into the small project area (the project area of the contacting member). Therefore, the chest compression can be efficiently performed.

The contacting member may be fixed to or supported by a substantially central part of the first housing member.

According to the configuration, even when the place where the rescuer applies compression is deviated, the pressure is concentrated in the central portion, and therefore the chest compression can be adequately performed.

A surface of the contacting member may have a planar shape which has a width and a height, and the width and the height are different from each other in length.

According to the configuration, the contacting member is fixed so as to extend along the sternum, and the cardiopulmonary resuscitation assisting device can be prevented from being positionally displaced during the chest compression.

The planar shape may have a width of 3 cm to 4.5 cm.

Since the width of the planar shape ranges within the above-described size range, the contacting member can be surely fixed to the sternum of the rescuee, and the cardiopulmonary resuscitation assisting device can be prevented from being positionally displaced during the chest compression.

The planar shape may have a height of 7 cm to 10 cm.

Since the height of the planar shape ranges within the above-described size range, the chest compression can be stably performed while the contact area between the rescuee and the cardiopulmonary resuscitation assisting device is maintained at a given value or more.

According to the presently disclosed subject matter, is possible to provide a cardiopulmonary resuscitation assisting device which can appropriately assist cardiopulmonary resuscitation (CPR) with a small number of components.

What is claimed is:

1. A cardiopulmonary resuscitation assisting device which is to be placed between a rescuee and a rescuer, during execution of cardiopulmonary resuscitation (CPR), assist the cardiopulmonary resuscitation, the cardiopulmonary resuscitation assisting device comprising:
a first housing member constituting a housing, and having a spring-like property.

2. The cardiopulmonary resuscitation assisting device according to claim 1, further comprising:
a second housing member constituting the housing, connected to the first housing member, and formed by a non-repulsive member.

3. The cardiopulmonary resuscitation assisting device according to claim 1, wherein
the first housing member is a plate spring.

4. The cardiopulmonary resuscitation assisting device according to claim 1, wherein
the first housing member includes an embossed portion having a convex shape, in a substantially central part.

5. The cardiopulmonary resuscitation assisting device according to claim 2, wherein
the second housing member includes a plurality of projections which are contacted with an inner edge of the first housing member, thereby fixing or supporting the first housing member.

6. The cardiopulmonary resuscitation assisting device according to claim 1, further comprising:
a contacting member which is connected to the first housing member to be in contact with a chest of the rescuee.

7. The cardiopulmonary resuscitation assisting device according to claim 6, wherein
a project area of the contacting member is smaller than a project area of the first housing member.

8. The cardiopulmonary resuscitation assisting device according to claim 6, wherein
the contacting member is fixed to or supported by a substantially central part of the first housing member.

9. The cardiopulmonary resuscitation assisting device according to claim 6, wherein
a surface of the contacting member has a planar shape which has a width and a height, and the width and the height are different from each other in length.

10. The cardiopulmonary resuscitation assisting device according to claim 9, wherein
the planar shape is an elliptic shape.

11. The cardiopulmonary resuscitation assisting device according to claim 9, wherein
the planar shape has a width of 3 cm to 4.5 cm.

12. The cardiopulmonary resuscitation assisting device according to claim 9, wherein
the planar shape has a height of 7 cm to 10 cm.

13. A cardiopulmonary resuscitation assisting device comprising:
a first housing member which constitutes a housing on a side of a chest of a rescuee; and
a contacting member which is connected to the first housing member to be in contact with the chest of the rescuee, wherein
a project area of the contacting member is smaller than a project area of the first housing member.
